(19) United States
(12) Patent Application Publication
(10) Pub. No.: US 2025/0258016 A1
(43) Pub. Date: Aug. 14, 2025

(54) Sensor Calibration

(71) Applicant: The United States of America as represented by the Secretary of the Navy, Keyport, WA (US)

(72) Inventor: Mark E. Paulus, Poulsbo, WA (US)

(21) Appl. No.: 19/051,078

(22) Filed: Feb. 11, 2025

Related U.S. Application Data
(60) Provisional application No. 63/553,131, filed on Feb. 13, 2024.

(51) Int. Cl. G01C 25/00; G01C 21/16

(52) U.S. Cl. CPC G01C 25/00; G01C 21/1654

(57) ABSTRACT

Methods, and systems of use, for sensor calibration. The method may comprise calibrating an attitude accelerometer of a sensor using an elliptical-fitting method, which may be based on calibration positions. The method may further calibrate a magnetometer of the sensor using a dot-product invariance (DPI) method, which may be based on the calibration positions. The method may comprise determining a magnetometer-calibration status of the magnetometer based on a chi squared distribution test method and a root mean square error (RMSE) method of dot-products generated by the DPI method. The method may further comprise calibrating an acoustic accelerometer of the sensor using the DPI method, which may be based on relative-values of a shape matrix. The method may comprise scaling an acoustic accelerometer of the sensor using a hydrophone. The system may comprise a sensor-error engine configured to perform steps of the disclosed methods.

### CROSS REFERENCE TO RELATED APPLICATION

This non-provisional patent application claims priority to, and incorporates herein by reference in their entirety, U.S. Provisional Patent Application No. 63/553,131 that was filed Feb. 13, 2024.

### STATEMENT OF GOVERNMENT INTEREST

The embodiments of the present disclosure may be manufactured and used by or for the Government of the United States of America for governmental purposes without the payment of any royalties thereon or therefor.

### FIELD OF THE DISCLOSURE

The present disclosure relates in general to the field of calibration of sensors, and in particular to systems and methods and apparatuses for vector sensor calibration.

### BACKGROUND

Basic techniques for the manual calibration of sensors are known in the art. However, prior methods for the manual sensor calibration are slow, labor-intensive and produce inconsistent results. Improved solutions are desired for automating the calibration processes of vector sensors. Features of the present disclosure overcome various deficiencies of the prior art by providing a method, system and apparatus having advantages that will become apparent from the following disclosure.

### BRIEF SUMMARY OF THE DISCLOSURE

The following presents a simplified summary of the disclosure in order to provide a basic understanding of some aspects of the disclosure. This summary is not an extensive overview of the disclosure. It is intended neither to identify key or critical elements of the disclosure, nor to delineate the scope of the disclosure. Its sole purpose is to present some concepts, in accordance with the disclosure, in a simplified form as a prelude to the more detailed description presented herein.

In accordance with certain embodiments, the disclosed calibration systems, devices and methods may be utilized to calibrate sensors such as vector sensors. The disclosed method may comprise the step of calibrating an attitude accelerometer of a sensor using an elliptical-fitting method. The step of calibrating the attitude accelerometer may be based on calibration positions. The method may further comprise calibrating a magnetometer of the sensor using a dot-product invariance method. The step of calibrating the magnetometer may be based on the calibration positions. The dot-product invariance method may generate magnetometer dot-products of magnetic field vectors and acceleration field vectors for the magnetometer.

In certain embodiments, the method may comprise the step of determining a magnetometer-calibration status of the magnetometer based on a chi squared distribution test method and a root mean square error (RMSE) method of the generated dot-products. The magnetometer-calibration status may be based on a significance-level for a chi squared distribution and a maximum RMSE value. The maximum RMSE value may be based on the standard deviation of measured dot-products of the magnetometer when the sensor is held stationary.

In some embodiments, the disclosed method may comprise the step of calibrating an acoustic accelerometer of the sensor using the dot-product invariance method, whereby the dot-product invariance method generates acoustic dot-products for the acoustic accelerometer, wherein the step of calibrating the acoustic accelerometer is based on relative-values of a shape matrix based on acoustic dot-products for the acoustic accelerometer. The method may comprise the step of scaling an acoustic accelerometer of the sensor using a hydrophone. The hydrophone, the acoustic accelerometer, the attitude accelerometer and the magnetometer may be mounted within the sensor.

The disclosed system may comprise a sensor-error engine configured to perform one or more of the steps of the disclosed methods. Further advantages and features of the present disclosure are illustrated in the drawings and described in detail below.

### BRIEF DESCRIPTION OF THE DRAWINGS

The foregoing and other objects, features, and advantages for embodiments of the present disclosure will be apparent from the following more particular description of the embodiments as illustrated in the accompanying drawings, in which reference characters refer to the same components throughout the various views. The drawings are not necessarily to scale; emphasis instead being placed upon illustrating principles of the present disclosure.

FIG. 1 is a flowchart illustrating an embodiment of a calibration step for the disclosed method, in accordance with certain embodiments of the present disclosure.

FIG. 2 illustrates an exemplary representation of properties for a vector sensor not requiring calibration, based on the lack of measurement errors, in accordance with certain embodiments of the present disclosure.

FIG. 3 illustrates an embodiment of a representation depicting an embodiment of a vector sensor having biased or rotated properties and orientation errors due to assembly errors that result in measurement errors when using the vector sensor, in accordance with some embodiments.

FIG. 4 illustrates an embodiment of a representation depicting an aligned coordinate system based on the North-East-Down (NED) coordinate system with field vectors including the gravitational field vector g and the magnetic field vector h such that a vector sensor may be calibrated as described herein by rotating the reference frame of the vector sensor to the reference frame of the NED coordinate system, in accordance with some embodiments.

FIG. 5 illustrates an embodiment of a representation depicting an example of the goodness-of-fit determination using an embodiment of a Dot Product Invariant method in the calibration of a vector sensor, showing a comparison of calibrated measurements or values with a reference frame of the Earth, in accordance with certain embodiments of the present disclosure.

FIG. 6 illustrates an example of 16-position calibration for a vector sensor, based on the utilization of a Dot Product Invariant method to evaluate calibration values or measurements, in accordance with certain embodiments of the present disclosure.

FIG. 7 illustrates an embodiment of a spherical representation depicting an example of eight positions for evaluation during calibration of a vector sensor, based on the utilization of a χ² test wherein data may be binned into the eight positions denoted by the crosses and dots, in accordance with certain embodiments of the present disclosure.

FIG. 8 illustrates an embodiment of a tetradecahedron representation depicting an example of positions for evaluation during calibration of a vector sensor, enabling a visual indication of alignment for the calibration positions using a truncated-cube form of a tetradecahedron having numbered sides or faces that have direction vectors and a directional arrow pointing towards the Earth's magnetic North, wherein the representation is illustrated around a calibration fixture, in accordance with certain embodiments of the present disclosure.

FIG. 9 illustrates an embodiment of an elliptical representation depicting an example of positions for evaluation during calibration of a vector sensor, based on four data points measured at predetermined angles along the N-S axis and the W-E axis, resulting in one or more unique elliptical representations, in accordance with certain embodiments of the present disclosure.

FIG. 10 is a sectional view of an example of a vector sensor, which may be calibrated in accordance with certain embodiments of the present disclosure.

FIG. 11 is a flowchart illustrating an embodiment of the disclosed method, in accordance with certain embodiments of the present disclosure.

FIG. 12 is a block diagram illustrating examples of components for the disclosed system, in accordance with certain embodiments of the present disclosure.

### DETAILED DESCRIPTION

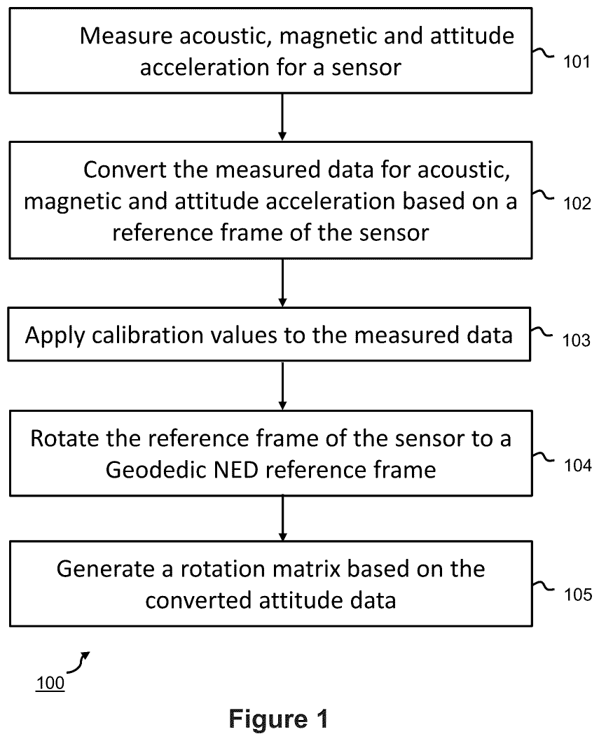

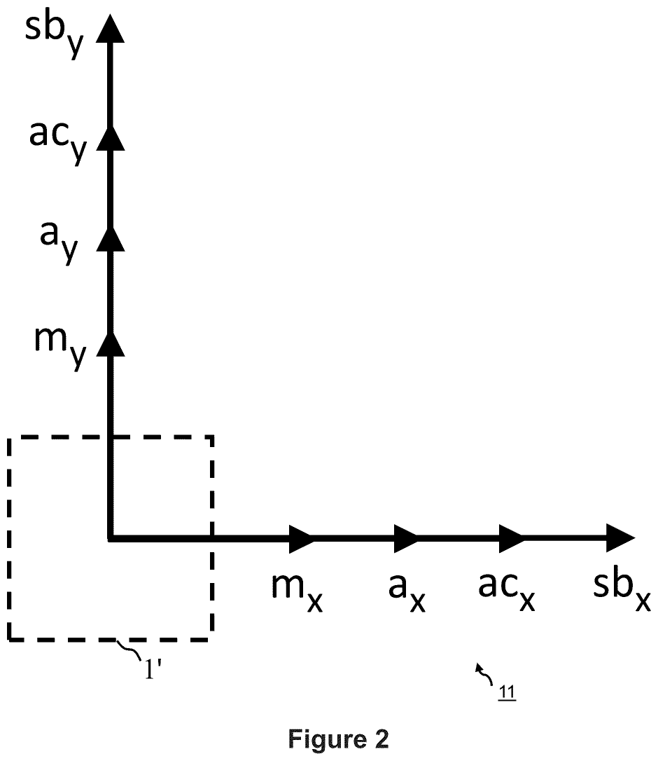

Reference will be made in detail to the embodiments of the present disclosure, examples of which are illustrated in the accompanying drawings. The present disclosure may be embodied in various forms such as systems and methods 100 for the calibration, as shown in FIG. 1, of a vector sensor 1 as may be depicted in FIG. 2 by a sensor representation 1′. In some embodiments, a calibration method 100 of a vector sensor 1 may be performed prior to using the vector sensor 1. Persons skilled in the art appreciate that uncalibrated sensors 1 may result in unreliable data. A benefit of the present disclosure may include the efficient and reliable calibration of sensors 1.

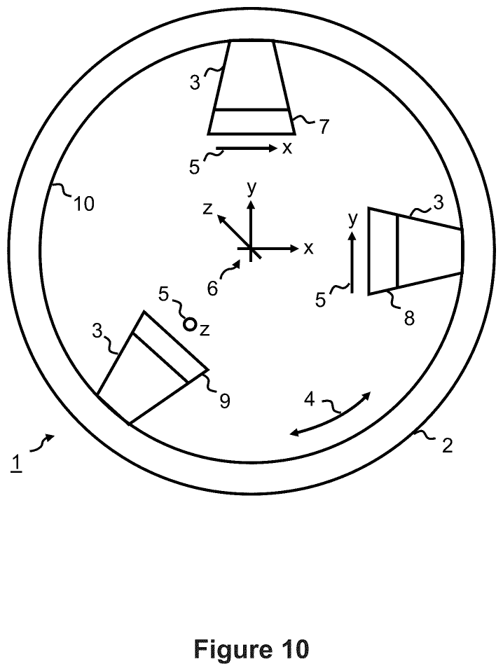

The structure and internal elements of vector sensors 1 are well known in the art, as are reference frames and orientations and coordinate systems thereof and of the Earth, and are further described in U.S. Pat. Nos. 6,820,025 and 7,066,026 and 9,016,129 and 10,823,813 which are incorporated by reference herein in their entirety. An example of a vector sensor 1 and its components is depicted in FIG. 10, in accordance with an embodiment. In some embodiments, a vector sensor 1 may comprise a sensor body or housing 2 and at least three sensing/sensor elements or triads 3 which may be mounted on or within the sensor body 2. A vector sensor 1 may be manufactured or acquired with an unknown orientation 4 and require calibration prior to being used. In an embodiment, the vector sensor 1 may comprise five reference frames 5. In some embodiments, the reference frames 5 may comprise a reference frame 5 for each sensor triad 3. An orientation 4 and a reference frame 5 may be associated with the body 2 of the sensor 1, and another reference frame 5 may be associated with the coordinate system 6 of the Earth, in accordance with certain embodiments.

In some embodiments, a set of the sensor triads 3 may comprise sensor elements 3 selected from a group consisting of attitude accelerometers 7, magnetometers 8 and acoustic accelerometers 9. In an embodiment, the set of the sensor triads 3 may comprise orthogonal x, y, z sensors 1. In certain embodiments, a vector sensor 1 may comprise tri-axial form factors, wherein all the sensor elements 3 may be provided in one package or a single member. Acoustic vector sensors 1 may use three orthogonally oriented accelerometers 7 to measure the particle motion associated with a pressure wave.

As may be appreciated in certain embodiments, referring back to FIG. 1, advantages of the presently disclosed calibration methods 100 of the vector sensor 1 may include a determination of the amplitude of each sensor element 3 and an alignment of all sensor elements 3 to a single coordinate system 6. In some embodiments, the calibration 100 may comprise a step of implementing a Dot Product Invariance (DPI) method such that in-field calibration may be performed without the use of expensive position tables, fixtures, acoustic sources or magnetic field generators.

In an embodiment, channels 11 of an attitude accelerometer 7 (the channel 11 thereof is denoted in FIG. 2 as a), magnetometer 8 (having a channel 11 denoted as m), acoustic accelerometer 7 (having a channel 11 denoted as ac) and sensor body 2 (having a channel 11 denoted as sb) may be aligned as represented in the two-dimensional illustration depicted in FIG. 2 for a vector sensor 1 that is well-made manufactured without needing substantial calibration. For such a vector sensor 1, only the amplitude scaling of each channel 11 may be required during calibration, in accordance with certain embodiments.

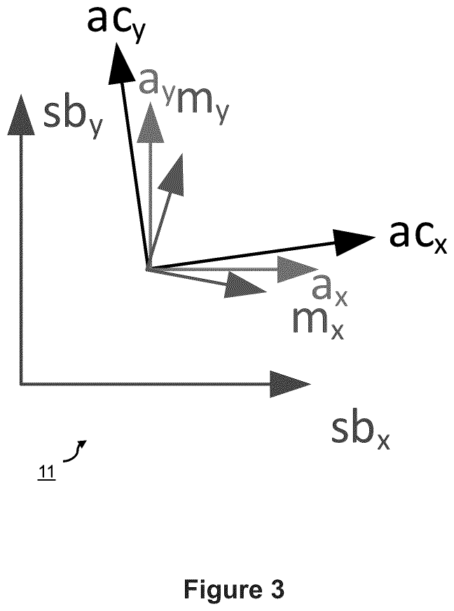

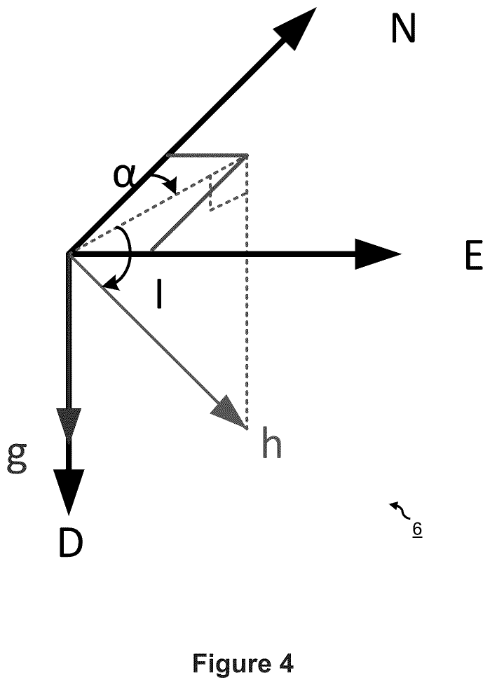

In some embodiments, errors during assembly of a vector sensor 1 may result in imprecise placement or orientation of components and unsatisfactory manufacturing tolerances that require additional calibration. Due to such assembly errors, a sensor 1 may be rotated, not orthogonal (x,y,z of one tri-axial sensor like a magnetometer 8), or biased. Examples of potential types of errors in the orientation 4 of a sensor 1 may be appreciated from the illustration shown in FIG. 3. The orientation 4 of a sensor 1 may be unknown. In accordance with certain embodiments of the calibration method 100, the orientation 4 may be measured and calibrated. Referring back to FIG. 1, as further described below, the presently disclosed calibration method 100 may include the step of taking the sensor measurements for a vector sensor 1 having an initially unknown orientation 4, which may be determined to be biased as illustrated in FIG. 3, and the step of converting the sensor orientation 4 to an aligned coordinate system 6 as depicted in FIG. 4. The calibration method 100 may further include the steps of a fifth-coordinate system 6 taking the reference frame 5 for a vector sensor 1, denoted by the x,y,z components, and rotating it to a reference frame 5 or coordinate system 6 for the Earth. Vector sensors 1 may be used for the directional measurement of objects, in comparison to the absolute position of the objects. Accordingly, a coordinate rotation may be determined and utilized without additional translations.

In certain embodiments, the North-East-Down (NED) coordinate system 6 may be utilized by the calibration method 100 as disclosed herein. FIG. 4 illustrates a NED coordinate system 6 with field vectors. The NED coordinate system 6 shown in FIG. 4 includes the gravitational field vector g and the magnetic field vector h. Measurements of these vectors will be used to calibrate the sensor 1 as well as rotate the reference frame 5 for a vector sensor 1 to the NED coordinate system 6 or another reference frame 5 of the Earth.

Traditional calibration methods may merely rely on an external source. Those methods often require expensive sources or laboratories to complete the calibration. For many sensors 1, i.e. the magnetic sensor, the calibration is not stable over time. In some circumstances, in-field calibrations are required to provide the most accurate measurements. The presently disclosed calibration methods 100 use existing Earth fields, such as gravity and magnetism, to overcome the difficulties faced by typical methods. These field parameters are generally fixed at certain locations. As discussed in detail herein, use of existing Earth fields eliminates the traditional requirement for knowing sensor body alignment and therefore reduces complexity of testing and manufacturing.

In accordance with certain embodiments, the determination of acoustic directional properties may be performed via the presently disclosed method 100, referring back to FIG. 1. The method 100 may comprise the step of measuring acoustic, magnetic and attitude acceleration [block 101]. In an embodiment, this step may comprise measuring field-vectors for an attitude accelerometer, a magnetometer, and an acoustic accelerometer. The measured acceleration may comprise an acceleration vector. The method 100 may further comprise the step of converting acoustic, magnetic and attitude acceleration to a reference frame 5 of a sensor 1 [block 102]. The converting step may comprise applying calibration values to measured data [block 103]. The method 100 may further comprise the step of rotating the sensor reference frame 5 to a NED reference frame 5, which may be a Geodedic NED reference frame 5 [block 104]. This rotating step may comprise defining or generating a rotation matrix based on measured attitude values [block 105].

In some embodiments, the attitude accelerometer (α) 7, magnetometer (m) 8, acoustic accelerometer (ac) 9 may be calibrated to a constant reference frame 5. In certain embodiments, the presently disclosed methods 100 may focus on Earth fields. Accordingly, the reference frame 5 of an accelerometer 7, 9 may be utilized as described herein. For each tri-axial sensor 1, the error may be described by the following equation:

$$v = St + b$$

where b is the bias vector, t is the true stimulus of the sensor 1, ν is the measurement based on the sensor errors, and S is the sensor error matrix. Alternately, the above equation may be expanded by applying the following sensor error matrix:

$$[ \begin{matrix}{v}_{x} \\ {v}_{y} \\ {v}_{z}\end{matrix} ] = [ \begin{matrix}{S}_{11} & {S}_{12} & {S}_{13} \\ {S}_{21} & {S}_{22} & {S}_{23} \\ {S}_{31} & {S}_{32} & {S}_{33}\end{matrix} ] [ \begin{matrix}{t}_{x} \\ {t}_{y} \\ {t}_{z}\end{matrix} ] + [ \begin{matrix}{b}_{x} \\ {b}_{y} \\ {b}_{z}\end{matrix} ]$$

In accordance with the above-described equation for measured sensor errors, this applied sensor error matrix may be classified as scale factor error (sf), misalignment and non-orthogonal errors (m), and soft iron errors (si) for magnetometers 8 only where these individual error contributions may be described via the following equation:

S=S_{sf}SₘSₛᵢ

where the individual error matrices are defined as follows:

$${S}_{sf} = [ \begin{matrix}s {f}_{x} & 0 & 0 \\ 0 & s {f}_{y} & 0 \\ 0 & 0 & s {f}_{z}\end{matrix} ]$$

$${S}_{m} = [ \begin{matrix}1 & - {ϵ}_{x} & - {ϵ}_{y} \\ {ϵ}_{z} & 1 & - {ϵ}_{x} \\ - {ϵ}_{y} & {ε}_{x} & 1\end{matrix} ]$$

$${S}_{si} = [ \begin{matrix}{α}_{xx} & {α}_{xy} & {α}_{xz} \\ {α}_{y x} & {α}_{y y} & {α}_{y z} \\ {α}_{z x} & {α}_{zy} & {α}_{z z}\end{matrix} ]$$

In certain embodiments, a determination of the individual error contributions may not be required because the overall error matrix S may be determined instead.

In some embodiments, the presently disclosed vector sensor calibration may utilize the above-described equation for measured sensor errors in order to establish the calibration where the external source is used to represent t and the sensor measurement is taken as ν, where the calibration values S and b are determined using methods 100 such as linear least squares as described herein. This calibration method 100 may require that the calibration be performed and aligned to the body reference frame 5, which has been traditionally problematic when using sensors 1 that are not conducive to alignment such as spheres and cylinders.

In certain embodiments, when conducting field calibrations, the Earth's field may be used to represent t. Accordingly, the magnitude of the field may be known, and the direction may be based on the coordinate system (NED) 6 of the Earth. The orientation 4 of the sensor reference frame 5, however, may not be known in an embodiment. This uncertainty may limit the use of the least squares direct solution for the above-described equation for measured sensor errors, so alternate solutions have been developed and are described herein.

### Dot Product Invariant Method

Although varying methods disclosed herein may be used in some embodiments, in certain embodiments, the Dot Product Invariant (DPI) method may be used in the calibration method 100. In an embodiment, an attitude calibration may be performed first. This calibration may then be used to perform an acoustic calibration. An elliptical fit method may be used to determine the calibration 100 of attitude accelerometers 7, and the DPI method may be used for the axes of magnetometers 8 and the acoustic accelerometers 9.

In some embodiments using an ellipsoid model for a calibration problem, the sensor error model for the attitude accelerometers 7 may be defined by the following equation:

$$r = P a + e$$

where r is the raw measurement of the sensor 1 (including error), P is the shape matrix, a is the true measurement, and e is the bias vector. When solving the preceding equation in terms of the true measurement yields, the relationship may be described as follows:

$$a = N r - c$$

$$where$$

$$N = {P}^{- 1}$$

$$c = {P}^{- 1} e = N e$$

In certain embodiments for calibration with known external sources, r and a may be explicitly known and/or predetermined. Although the magnitude of Earth's acceleration field g has known direction and amplitude, it may not be known in the sensor coordinate frame 5 without external references. In some embodiments, this determination may be conducted on a table or cube that could position the sensor 1 in known positions. Nonetheless, alignment to the mounting body may be performed in this calibration for verification of results. The acoustic stimulus and magnetic stimulus may require orientation to the sensor body reference frame 5 to ensure alignment. In certain embodiments requiring more precise calibrations, the presently disclosed methods 100 may be performed with a pin to ensure repeatability and accuracy. In some embodiments for calibrations in the field, when such a solution may not be available, the direct use of Earth's acceleration field may be alternatively used. A limitation in some embodiments using this method 100 may be that the amplitude of the g is known but the orientation 4 to the sensor reference frame 5 may not be predetermined. The data used by this method 100 may therefore include data where the sensor reference frame 5 is oriented in all angles relative to g. This may be accomplished by rotating the sensor during data acquisition. In certain embodiments, the accelerometer 7 and the magnetometer 8 may be calibrated using this method 100. At a predetermined location during calibration, the amplitude of g is known and may be used to as the known vector a such that a constant scaling value be defined as follows:

$$cons = g \cdot g = a \cdot a = ( Nr - c ) \cdot ( Nr - c )$$

Using Dot Product rules and expanding yields, this equation may be described as follows:

$$cons = g \cdot g = a \cdot a = {( Nr - c )}^{′} ( Nr - c )$$

$$g \cdot g = {‖ g ‖}^{2} = {( N r - c )}^{′} ( N r - c )$$

$$cons = {‖ g ‖}^{2} = ( {r}^{′} {N}^{′} - {c}^{′} ) ( N r - c )$$

$$cons = {‖ g ‖}^{2} = {r}^{′} {N}^{′} Nr - {c}^{′} Nr - {c}^{′} Nr + {c}^{′} c$$

$$cons = {‖ g ‖}^{2} = {r}^{′} {N}^{′} Nr - 2 {c}^{′} Nr + {c}^{′} c$$

In certain embodiments for calibration of vector sensors 1, N′N may be positive definite. Accordingly, the last iteration of the above-described equation may be represented in the form of an ellipsoid and may be adapted to be transformed by elliptical fitting techniques. As described herein, the elliptical fitting technique and ellipsoid form that is represented by the preceding equation may be expanded in accordance with certain embodiments of the present disclosure.

For the derivation in some embodiments of the elliptical fitting method, the equation notation will be defined using the quadratic form of an ellipsoid as represented by the following equation:

$${x}^{2} + {y}^{2} + {z}^{2} - U ( {x}^{2} + {y}^{2} - 2 {z}^{2} ) - V ( {x}^{2} - 2 {y}^{2} + {z}^{2} ) - 2 M x y - 2 N x z - 2 Pyz - Qx - R y - S z - T = 0$$

where x, y, z are the coordinate values and U, V, M, N, P, Q, R, S, T are constants that determine the shape and offset of the ellipsoid. This equation may be rearranged, as follows:

$${x}^{2} + {y}^{2} + {z}^{2} = U ( {x}^{2} + {y}^{2} - 2 {z}^{2} ) + V ( {x}^{2} - 2 {y}^{2} + {z}^{2} ) + 2 M x y + 2 N x z + 2 Pyz + Qx + R y + S z + T$$

Accordingly, the linear equation may be described as follows:

$$\begin{matrix}{x}_{1}^{2} + {y}_{1}^{2} + {z}_{1}^{2} \\ ⋮ \\ {x}_{i}^{2} + {y}_{i}^{2} + {z}_{i}^{2} \\ ⋮ \\ {x}_{n}^{2} + {y}_{n}^{2} + {z}_{n}^{2}\end{matrix} = [ \begin{matrix}{x}_{1}^{2} + {y}_{1}^{2} - 2 {z}_{1}^{2} & {x}_{1}^{2} - 2 {y}_{1}^{2} + {z}_{1}^{2} & 2 {x}_{1} {y}_{1} & 2 {x}_{1} {z}_{1} & 2 {y}_{1} {z}_{i} & {x}_{i} & {y}_{i} & {z}_{i} & 1 \\ & & ⋮ & & & & & & \\ {x}_{i}^{2} + {y}_{i}^{2} - 2 {z}_{i}^{2} & {x}_{i}^{2} - 2 {y}_{i}^{2} + {z}_{i}^{2} & 2 {x}_{i} {y}_{i} & 2 {x}_{i} {z}_{i} & 2 {y}_{i} {z}_{i} & {x}_{i} & {y}_{i} & {z}_{i} & 1 \\ & & ⋮ & & & & & & \\ {x}_{n}^{2} + {y}_{n}^{2} - 2 {z}_{n}^{2} & {x}_{n}^{2} - 2 {y}_{n}^{2} + {z}_{n}^{2} & 2 {x}_{n} {y}_{n} & 2 {x}_{n} {z}_{n} & 2 {y}_{n} {z}_{n} & {x}_{n} & {y}_{n} & {z}_{n} & 1\end{matrix} ] [ \begin{matrix}U \\ V \\ M \\ N \\ P \\ Q \\ R \\ S \\ T\end{matrix} ]$$

where i is the index representing the ith coordinate and n is the total number of coordinates that are being fit. This linear equation may be written in matrix form, as follows:

c_{LS}=Λs_{LS}

where

$${c}_{LS} = {[ \begin{matrix}{x}_{1}^{2} + {y}_{1}^{2} + {z}_{1}^{2} \\ ⋮ \\ {x}_{i}^{2} + {y}_{i}^{2} + {z}_{i}^{2} \\ ⋮ \\ {x}_{n}^{2} + {y}_{n}^{2} + {z}_{n}^{2}\end{matrix} ]}_{n \times 1}$$

$$Λ = {[ \begin{matrix}{x}_{1}^{2} + {y}_{1}^{2} - 2 {z}_{1}^{2} & {x}_{1}^{2} - 2 {y}_{1}^{2} + {z}_{1}^{2} & 2 {x}_{1} {y}_{1} & 2 {x}_{1} {z}_{1} & 2 {y}_{1} {z}_{i} & {x}_{i} & {y}_{i} & {z}_{i} & 1 \\ & & ⋮ & & & & & & \\ {x}_{i}^{2} + {y}_{i}^{2} - 2 {z}_{i}^{2} & {x}_{i}^{2} - 2 {y}_{i}^{2} + {z}_{i}^{2} & 2 {x}_{i} {y}_{i} & 2 {x}_{i} {z}_{i} & 2 {y}_{i} {z}_{i} & {x}_{i} & {y}_{i} & {z}_{i} & 1 \\ & & ⋮ & & & & & & \\ {x}_{n}^{2} + {y}_{n}^{2} - 2 {z}_{n}^{2} & {x}_{n}^{2} - 2 {y}_{n}^{2} + {z}_{n}^{2} & 2 {x}_{n} {y}_{n} & 2 {x}_{n} {z}_{n} & 2 {y}_{n} {z}_{n} & {x}_{n} & {y}_{n} & {z}_{n} & 1\end{matrix} ]}_{n \times 9}$$

$${S}_{LS} = {[ \begin{matrix}U \\ V \\ M \\ N \\ P \\ Q \\ R \\ S \\ T\end{matrix} ]}_{9 \times 1}$$

Accordingly, the normal equation which performs a linear least squares estimate may be described as follows:

Λ^{T}c_{LS}=Λ^{T}Λs_{LS}

where the coefficients may be solved for using the following equation:

$${s}_{L S} = {( {Λ}^{T} Λ )}^{- 1} {Λ}^{T} {c}_{L S}$$

Calibration may be based on the results of this equation, factoring in any acceptable numerical uncertainty in the solution as may be appreciated by those skilled in the art.

Alternatively, in some embodiments, a representation of an arbitrary ellipsoid may be defined by the following equation:

$${( a - b )}^{T} A ( a - b ) = c o n s$$

where a is the x, y,z coordinate point, b is the x, y,z center point, and A is a symmetric positive definite matrix. Expanding the above equation may yield an equation defined as follows:

$${a}^{T} A a - 2 {b}^{T} A a + {b}^{T} Ab - cons = 0$$

Equating the preceding equation, with the above-described equation that represents the quadratic form of an ellipsoid, may yield the following:

$$A = [ \begin{matrix}1 - U - V & - M & - N \\ - M & 1 - U + 2 V & - P \\ - N & - P & 1 - 2 U - V\end{matrix} ]$$

$$b = \frac{1}{2} {A}^{- 1} [ \begin{matrix}Q \\ R \\ S\end{matrix} ]$$

$$cons = T + {b}^{T} Ab$$

The ellipsoid solution may be determined using the above-described equation that is based on the solved coefficients. Based on the above-described expanded equation and the above-described equation that represents the quadratic form of an ellipsoid, a solution may be represented in matrix form as it relates to the disclosed calibration problem.

With regard to the justification for certain embodiments of the disclosed elliptical solution, a person of skill in the art would appreciate that the above-described expanded equation is nearly identical to the above-described equation that used dot product rules, with the exception of the last two terms on the RHS. For the sake of clarity, that latter equation is reproduced below:

$$cons = {‖ g ‖}^{2} = {r}^{′} {N}^{′} Nr - 2 {c}^{′} Nr + {c}^{′} c$$

This preceding equation may be combined with the above-described equation that was solved in terms of true measurement yields, which was described as follows:

$$c = {P}^{- 1} e = N e$$

Such a combination may be rearranged, and may be described as follows:

$${r}^{′} {N}^{′} Nr - 2 {e}^{′} {N}^{′} Nr + {e}^{′} {N}^{′} Ne - {‖ g ‖}^{2} = 0$$

The preceding equation may match the above-described solution to the ellipsoid fit, which was defined as follows:

$${a}^{T} A a - 2 {b}^{T} A a + {b}^{T} Ab - cons = 0$$

where A=N′N and ∥g∥²=cons. In accordance with some embodiments, the ellipsoid fit may provide A and e. N may be determined from the ellipsoid result.

In certain embodiments, the ellipsoid solution may provide an optimal solution A and e which may map the ellipsoid to a spherical representation 16 as further described below. As the data sets are relative to the Earth field, the spherical mapping may not necessarily have a specific orientation requirement. Accordingly, the solution N may be rotated and still be a solution. In accordance with some embodiments, there may be multiple ways to decompose A to determine N. A certain form of N may be chosen. In an embodiment, the Choleski decomposition method may be used, where N is a lower triangular matrix. Accordingly, the x-axis and x-y plane of the sensor triad 3 may be unchanged during calibration. In certain embodiments, the Eigenvalue Decomposition Method may be used, where N is a symmetric matrix. In accordance with some embodiments, the N may have the following form:

$$N = [ \begin{matrix}{S}_{x} & 0 & {γ}_{x z} \\ {γ}_{x y} & {S}_{y} & {γ}_{y z} \\ 0 & 0 & {S}_{z}\end{matrix} ]$$

such that

$$A = {N}^{′} N = [ \begin{matrix}{S}_{x} & {γ}_{x y} & 0 \\ 0 & {S}_{y} & 0 \\ {γ}_{x z} & {γ}_{y z} & {S}_{z}\end{matrix} ] [ \begin{matrix}{S}_{x} & 0 & {γ}_{x z} \\ {γ}_{x y} & {S}_{y} & {γ}_{y z} \\ 0 & 0 & {S}_{z}\end{matrix} ]$$

which may yield

$$A = [ \begin{matrix}{S}_{x}^{2} + {γ}_{x y}^{2} & {S}_{y} {γ}_{x y} & {S}_{x} {γ}_{x z} + {γ}_{x y} {γ}_{y z} \\ {S}_{y} {γ}_{x y} & {S}_{y}^{2} & {S}_{y} {γ}_{y z} \\ {S}_{x} {γ}_{x z} + {γ}_{y z} {γ}_{x y} & {S}_{y} {γ}_{y z} & {γ}_{x z}^{2} + {γ}_{y z}^{2} + {S}_{z}^{2}\end{matrix} ]$$

The terms of the preceding equation may be equated with the above-described equation:

$$A = [ \begin{matrix}1 - U - V & - M & - N \\ - M & 1 - U + 2 V & - P \\ - N & - P & 1 - 2 U - V\end{matrix} ]$$

which may yield

$${s}_{y} = \sqrt{{A}_{22}}$$

$${γ}_{y z} = \frac{{A}_{32}}{{S}_{y}}$$

$${γ}_{x y} = \frac{{A}_{21}}{{S}_{y}}$$

$${S}_{x} = \sqrt{{A}_{11} - {γ}_{x y}^{2}}$$

$${γ}_{x z} = \frac{{A}_{31} - {γ}_{y z} {γ}_{x y}}{{S}_{x}}$$

$${S}_{z} = \sqrt{{A}_{33} - ( {γ}_{x z}^{2} + {γ}_{y z}^{2} )}$$

These equations may be used to solve the accelerometer calibration problem, as described herein. In some embodiments, such a solution may calibrate all the accelerometers sensor values to the z axis of the accelerometer 7. In an embodiment, the body frame 5 may not necessarily be used for calibration. When the accelerometer 7 is calibrated, the magnetometer 8 and the acoustic axis may be calibrated to the same reference frame 5.

In certain embodiments, using a calibrated tri-axial accelerometer 7 as a baseline may allow calibration of the magnetometer 8 to the same reference frame 5. While other methods may calibrate the magnetometer 8 independently without accounting for misalignment of the axes of the magnetometer 8 and accelerometer 7, the presently disclosed DPI method may account for the scale factor, non-orthogonal errors, axis misalignment, and reference frame alignment in one step. The sensor error model for the magnetometers 8 may be described as follows:

$$ν = K m + b$$

where ν is the raw measurement of the sensor 1 (including error), K is the shape matrix, m is the true measurement, and b is the bias vector. The K may include all errors associated with the magnetometer 8, with the exception of bias, such as scale factor, non-orthogonality soft iron effects, and hard iron effects. Solving the preceding equation in terms of the true measurement yields the following:

$$m = L ν - d$$

$$where$$

$$L = {K}^{- 1}$$

$$d = {K}^{- 1} b = L b$$

In accordance with certain embodiments, the Dot Product Invariance method may take advantage of the fact the Earth's magnetic and acceleration fields have a constant amplitude and a constant angle between them at a single location. This may be represented using the dot product as follow:

$$cons = g \cdot h = a \cdot m = a \cdot ( Lv - d )$$

By expanding the terms as descried herein for the acceleration calibration, the equation may be described as follows:

$$cons = g \cdot h = {a}^{′} ( L v - d )$$

Further expanding and simplifying the equation may result in the following:

$$g \cdot h = [ \begin{matrix}{a}_{x} & {a}_{y} & {a}_{z}\end{matrix} ] [ \begin{matrix}{L}_{11} & {L}_{12} & {L}_{13} \\ {L}_{21} & {L}_{22} & {L}_{23} \\ {L}_{31} & {L}_{32} & {L}_{33}\end{matrix} ] [ \begin{matrix}{v}_{x} \\ {v}_{y} \\ {v}_{z}\end{matrix} ] - ( {a}_{x} {d}_{x} + {a}_{y} {d}_{y} + {a}_{z} {d}_{z} )$$

$$g \cdot h = {L}_{11} {a}_{x} {v}_{x} + {L}_{12} {a}_{x} {v}_{y} + {L}_{13} {a}_{x} {v}_{z} + {L}_{21} {a}_{y} {v}_{x} + {L}_{22} {a}_{y} {v}_{y} + {L}_{23} {a}_{y} {v}_{z} + {L}_{31} {a}_{z} {v}_{x} + {L}_{32} {a}_{z} {v}_{y} + {L}_{33} {a}_{z} {v}_{z} - {a}_{x} {d}_{x} - {a}_{y} {d}_{y} - {a}_{z} {d}_{z}$$

And, combining unknown L and d terms may yield the following equation:

$$g \cdot h = [ {a}_{x} {v}_{x} {a}_{x} {v}_{y} {a}_{x} {v}_{z} {a}_{y} {v}_{x} {a}_{y} {v}_{y} {a}_{y} {v}_{z} {a}_{z} {v}_{x} {a}_{z} {v}_{y} {a}_{z} {v}_{z} - {a}_{x} - {a}_{y} - {a}_{y} ] [ \begin{matrix}{L}_{11} \\ {L}_{12} \\ {L}_{13} \\ {L}_{21} \\ {L}_{22} \\ {L}_{23} \\ {L}_{33} \\ {d}_{x} \\ {d}_{y} \\ {d}_{z}\end{matrix} ]$$

The preceding equation may represent a linear equation for n measured data points, and may be written as follows:

$$g \cdot h = c o n {s}_{n \times 1} = {D}_{n \times 10} d {2}_{10 \times 1}$$

where cons is the dot product of the Earth's magnetic and acceleration field, D is the matrix of measured values of the magnetic and Earth field, and d2 is the unknown shape matrix and bias calibration parameters. This equation may be solved using linear least squares and the normal equation, and described as follows:

$$d 2 = {( {D}^{′} D )}^{- 1} {D}^{′} cons$$

The dot product g·h may vary depending on the location, in accordance with some embodiments. In an embodiment, the benefit of a fully scaled solution may be obtained as a GPS position may be used to determine the angle between the field vectors. When the GPS position is not available, a relative calibration between the axis of the magnetometers 8 may be determined. In certain embodiments, the sensor output may be used to determine a bearing angle. Based on the calibration location, the angle between Earth's magnetic and acceleration field may vary. As this angle approaches 0° or 90°, the error may increase.

In accordance with certain embodiments, the calibration of the acoustic axes may be performed by an extension of the presently disclosed DPI method. The acoustic stimulus may be applied in a fixed direction relative to North, any other predetermined direction. In some embodiments, this angle may be around 45°. In an embodiment, the angle may be between 20° and 70°. Calibration may be performed using in water instrumentation or a land-based wave guide. The sensor 1 may be rotated relative to the source and the Earth's magnetic North. In certain embodiments, the known vector may be the magnetometer readings, and the acoustic shape and bias scaling factors may be determined. The constant, in an embodiment of the disclosed acoustic calibration, may also be determined. In some embodiments, the amplitude of the acoustic signal may not be predetermined or known precisely without a calibration hydrophone. In an embodiment, when the acoustic source is a constant amplitude, the shape and bias calibration values 14 may be determined and will be offset by a constant scaling factor described as follows:

$$cons = a {c}_{s} \cdot h = a c \cdot m = m \cdot ( ( Ms + f ) * Scale )$$

where acₛ is the acoustic source level, h is the magnetic field, ac is the calibrated acoustic measurement, M is the acoustic shape matrix, s is the measured acoustic source vector without calibration, f is the bias vector, and Scale is the unknown scale factor if the acoustic source level is not known. The cons value may be determined using the acoustic accelerometer measurements for acₛ without been properly scaled. Scaling may be performed by equating the measured acceleration to the measured data of a hydrophone 10, as defined below:

$$Scale = \frac{\sqrt{a {c}_{x}^{2} + a {c}_{y}^{2} + a {x}_{z}^{2}} * \frac{ρ c}{2 π {f}_{c al}}}{Hydrophone data}$$

This equation may convert or transform the measured acceleration to an equivalent pressure, assuming a plane wave. The velocity may be determined at the calibration frequency, and the accelerometer data may be scaled to the hydrophone data. This scaling factor may be applied, providing verification of the data during operations.

In accordance with certain embodiments of vector sensors 1 that have accelerometers 7 as the acoustic sensor 1, the calibration of the acoustic axes using accelerometers 7 may use a small shaker to excite the sensor 1 in a single direction. The sensor 1 may be rotated the same way as the magnetometer 8 and accelerometer 7 using a tetradecahedron representation 17 as described herein.

When performing a calibration, the validity of the calibration may be determined using a statistical analysis of the calibration. Generally, a standard may be employed to test individual values for calibration methods 100. The root sum square error, standard deviation or another standard measurement may be used to compare the calibrated values to the true value. In certain embodiments of the disclosed elliptical and DPI-fitting methods, such measurements may not be readily available. As disclosed herein, a comparison to the known dot product and evaluation of the coverage may be used to statistically analyze the calibration of a vector sensor 1.

In accordance with certain embodiments, the first part of the evaluation may comprise a comparison to the known dot product. The field acceleration g and the magnetic field h may have a constant dot product denoted as c that may be defined as follows:

$$c = g \cdot h$$

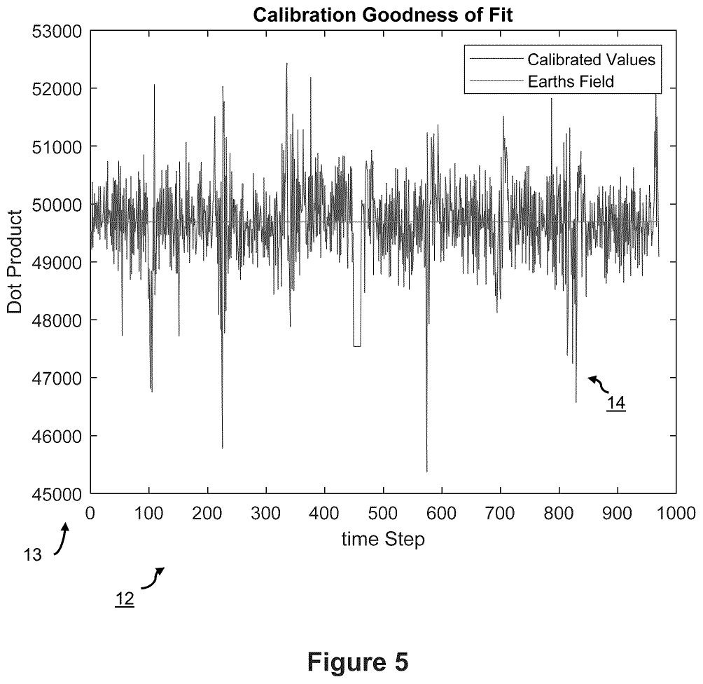

An estimate of this constant may be determined as follows:

$$\hat{c} = a \cdot m$$

where a is the calibrated acceleration, and m is the calibration magnetic field. The Root Mean Square Error (RMSE) may be determined as follows:

$$RMSE = \sqrt{\frac{{\sum }_{i = 1}^{N} {( {c}_{i} - {\hat{c}}_{i} )}^{2}}{N}}$$

where N is the number of calibration points. The lower the RMSE, the better fit to the data in accordance with certain embodiments. FIG. 5 illustrates an example of the goodness of fit representation 12 using the dot product 13 described herein, comparing the calibration values 14 with measures values for the field vector of the Earth.

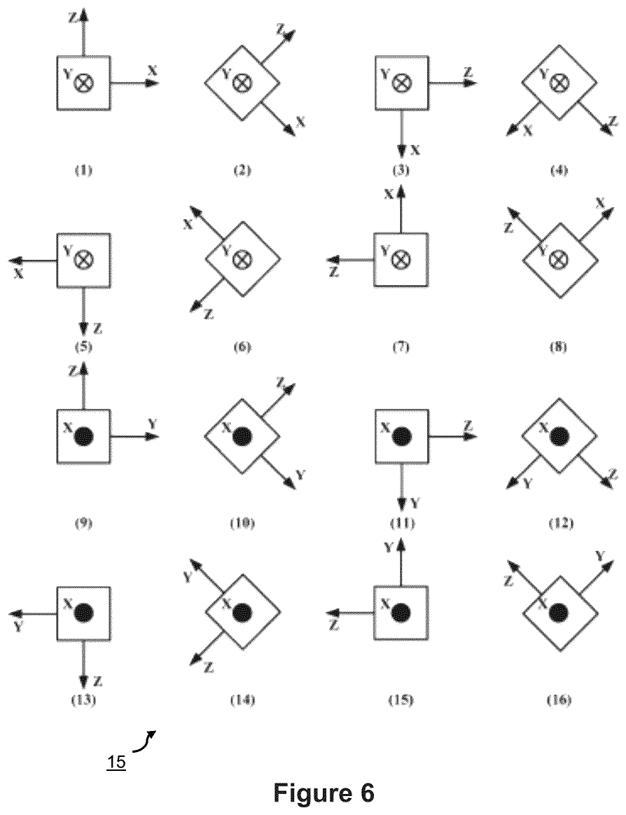

In some embodiments, this calibration method 100 may identify acceleration imparted to the attitude sensors 1 due to the motion of system during test. Such motion may represent a bias from the true calibration constant. Nonetheless, the RMSE may be subject to a false indication of goodness of fit 12′ when the sensor 1 is not moved, e.g. when a sensor 1 is held perfectly stationary for the entire calibration. Accordingly, under such conditions, the calibration values 14 may minimize the RMSE without providing a good calibration for the sensor 1 in different positions. This may be accomplished by ensuring the sensor 1 is rotated through all the possible positions. In certain embodiments, the sensor 1 may be rotated such that the coverage would be a spherical representation 16 covering the entire magnetic and acceleration field and all combinations thereof. This may be time consuming, and difficult to ensure exact repetitions. For accelerometers 7, a 16-position method may be implemented. This method may orient one axis perpendicular to the Earth's gravity field and may rotate around that axis in 45°-degree increments. FIG. 6 illustrates an example of 16-position calibration, as appreciated by those skilled in the art. In evaluation of the dot product 13, in accordance with some embodiments, values that are directly aligned with gravity (e.g., examples 1, 3, 5, 7, 9, 11, 13, 15 shown in FIG. 6) have zero in two calibration positions 15 on the acceleration vector. This may permit the magnetic field calibration values 14 (now shown) to have large variations. In order to account for this, a tetradecahedron representation 17 may be used as described herein.

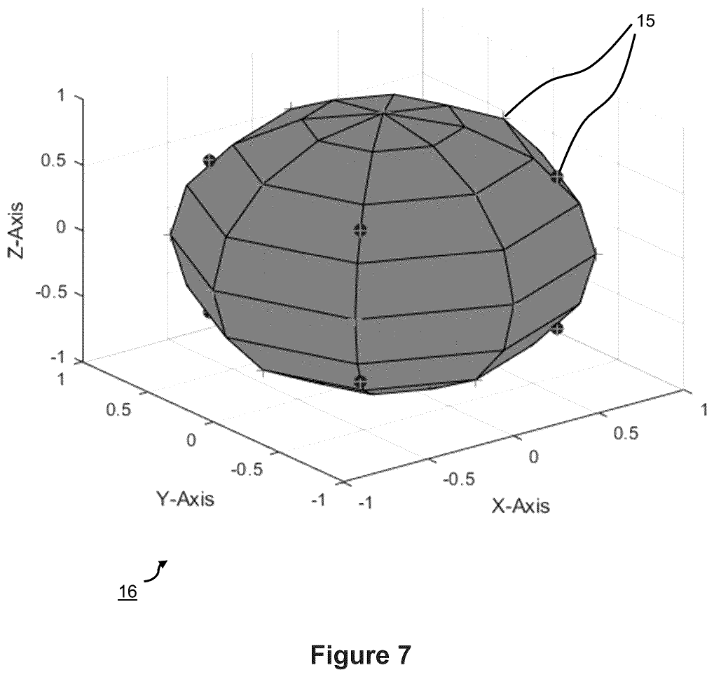

Optimization of the number of positions 15 may be appreciated by those skilled in the art. Evaluation of the positions 15 may be performed by binning the sphere positions 15, and then performing a χ² test relative to a normal distribution. In order to apply the χ² test, the positions 15 during calibration may be evaluated in accordance with some embodiments. The data may be binned into the calibration positions 15, as shown in FIG. 7, depicted by the green crosses and blue dots. While FIG. 7 illustrates an example using eight possible positions 15, a tetradecahedron representation 17 may use additional positions 15 as described herein.

Binning of the data may be performed as described by the equation below, where the field vector (a or m) can be used interchangeably:

$${Weight}_{k} = {max}_{k} ( {a}_{i} \cdot [ \begin{matrix}{x}_{k} \\ {y}_{k} \\ {z}_{k}\end{matrix} ] ) + {Weight}_{k - 1}$$

where

$$[ \begin{matrix}x \\ y \\ z\end{matrix} ]$$

are the positions 15 on the spherical representation 16 shown in FIG. 7 as indicated by the green crosses and blue dots, and k is a specific position. For each field vector aᵢ the value of the dot product 13 may be evaluated, and the maximum dot product may be binned using the weight variable. In an embodiment with ideal coverage, only the k coverage points corresponding to the N=8 off-axis points would have weight. When the weights are normalized with respect to 100 (percent coverage), then based on the uniform distribution, the equation may be defined as follows:

$$E ( {Weight}_{i} ) = \frac{100}{N} = \frac{100}{8} = 12.5 = e$$

where E (⋅) is the expected value operator and, i∈1, k . . . M where i is the index of the N weights corresponding to the eight off-axis points and M is the total number of possible locations. In other words, the only weight values that may be considered are the ones corresponding to the eight off-axis points. The χ² test statistic may evaluate the hypothesis that the eight off-axis points were the primary positions 15 of the calibration and that their distribution was uniform. The χ² test statistic may be defined as follows:

$$W = {χ}_{1 - α}^{2} = {\sum }_{i = 1}^{N} \frac{{( {o}_{i} - e )}^{2}}{e}$$

where e is the expected value determined from the above-described equation for the expected value operator, oᵢ is the ith weight of the N=8 off-axis points, and α is the significance level. The calculated χ² test statistic may be compared to the χ² distribution. In some embodiments, the χ_{1-α}² distribution may require α and the degrees of freedom ν may be defined (for uniform comparison) as follows:

$$ν = N - 1$$

The χ_{1-α}² distribution is well known and is often built into software as chi2inv.m for test statistic applications. For example, assume that W=20 for a certain calibration. Letting α=0.05 and ν=7, the χ_{0.95}² distribution value is R=14.0671. Accordingly, there may be less than a 1 in 20 chance that the distribution is uniform over the specified coverage area. When more confidence in the distribution was sought, α=0.75. The χ_{0.25}² distribution value is R=4.2549. As such, the current W value may have a less than 3 out of 4 chance of being uniform. Accordingly, it may be determined that better data is required. A low R value may drive a distribution of calibration values 14 that is more uniform.

The RMSE and the goodness of fit determination 12′ using the χ² distribution may be combined to assess quality of the calibration data. A significance level may be stated for χ² distribution and a maximum RMSE value. The maximum RMSE value may be based on the noise of the sensor 1. This may be determined by taking the standard deviation of the calibrated values when the sensor 1 is held stationary. If the RMSE is low enough and the χ² distribution is not rejected, the calibration may be considered satisfactory.

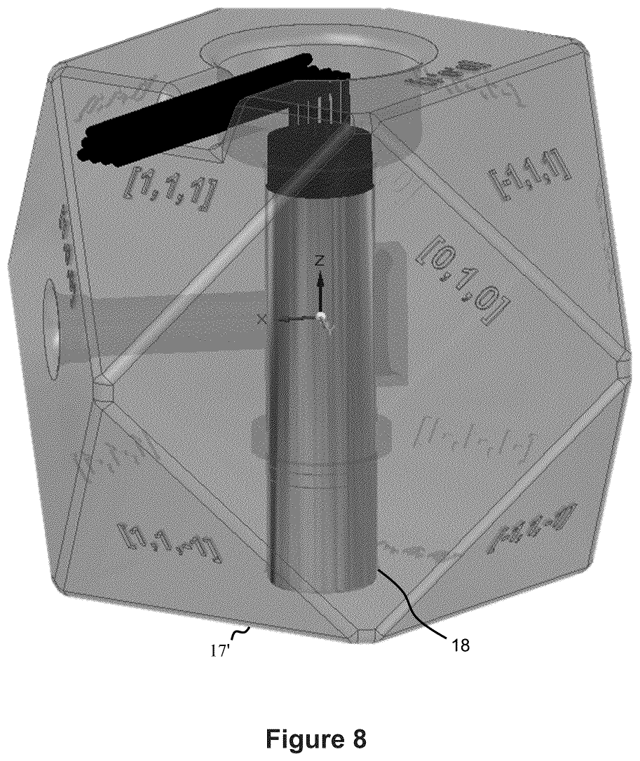

The above-described calibrations may be performed using a visual indication of alignment for the calibration positions 15. In accordance with certain embodiments, a specific form of a tetradecahedron representation 17 called a truncated-cube representation 17′ may be used to increase the ease of calibration. In some embodiments, the truncated-cube representation 17′ may comprise faces that have direction vectors as illustrated in FIG. 8. The calibration fixture 18 shown in FIG. 8 may be appreciated by those skilled in the art. Such a cube representation 17′ may have numbered sides for ease of processing, and a directional arrow that may face towards the Earth's magnetic North. In an embodiment, the inclusion of these two indicators allows repeatable field calibration of the vector sensors 1. Additional markings may be included to allow for mounting on a shaker table for acoustic calibration.

Continuous monitoring of the dot product 13 may be performed, in accordance with certain embodiments. During a bearing test, the dot product 13 may be continuously monitored. When the calibration is determined be satisfactory, the dot product 13 may match the field vector. In an embodiment, the RMSE of the dot product 13 may indicate that values above 30,000 are associated with bad data. Such an indication may be used to evaluate calibrations and the physical stability of the sensor 1 during the test.

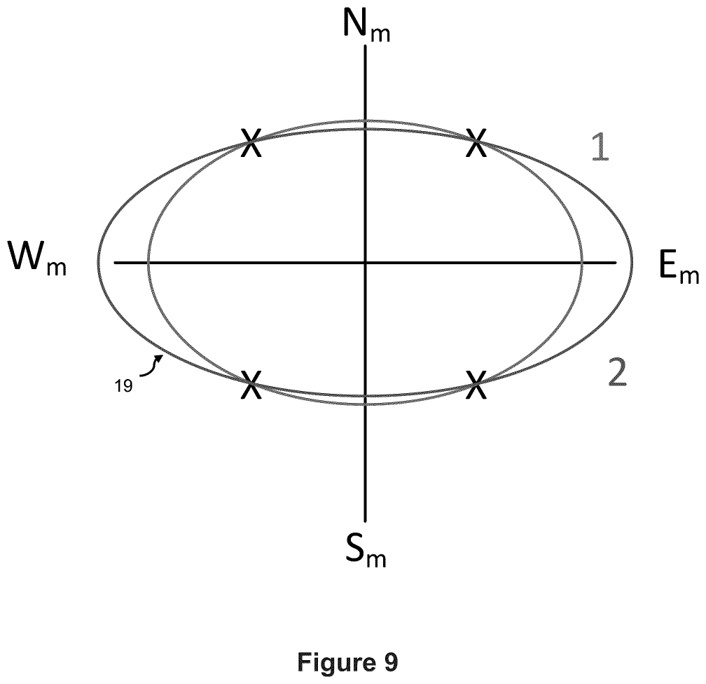

In some embodiments, calibrations may use 14-faces or positions 15. For example, in an embodiment, calibration testing may indicate poor calibration values 14 based on eight-position calibration. The calibration method 100 may be based on an elliptical fit, e.g. a 2D ellipse-fitting problem. Four data points may be taken at angles of 45°, 135°, −135° and 45°. This may be illustrated as the ellipses 19 shown in FIG. 9, which demonstrates that the four points may define more than one unique ellipse 19. Data points on the N-S axis and the W-E axis may allow for two uniquely defined ellipses 19. In some embodiments, the use of 14-face calibrations may provide consistent and satisfactory results.

In embodiments for the calibration of the acoustic axes, a base set may be used via an accelerometer 7 and the acoustic axes may be calibrated against the accelerometer axes. This method may be performed acoustically or by using a shaker to impart stimulation to the device.

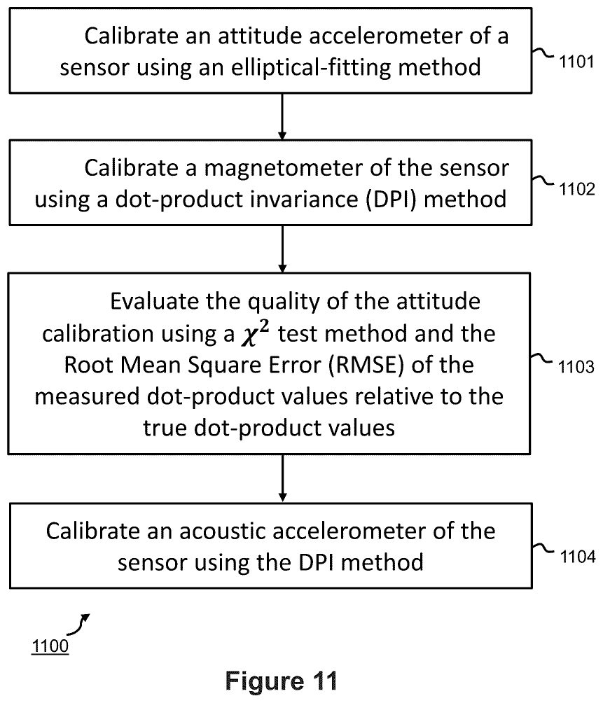

In certain embodiments, the measurement axes of a sensor 1 may be misaligned within a predetermined limit or range. Such conditions may exist when new three-axis accelerometers 7 and magnetometers 8 are received from a manufacturer. As illustrated in FIG. 11, in accordance with certain embodiments, the presently disclosed method 1100 may include the step of calibrating the attitude accelerometers 7 using the elliptical fit method [block 1101]. The calibration positions 15 may be the off-axis positions 15 of the tetradecahedron representation 17. The method 1100 may further include the step of calibrating the magnetic sensors 1 using the Dot Product Invariance (DPI) method [block 1102]. The same data from the attitude accelerometers 7 may be used when the sensor 1 was rotated within the magnetic field to avoid the axes alignment to the Earth's magnetic North. Based on the approximate latitude, the magnetic field vector may be determined. The method 1100 may take account of calibrations near the Earth's equator or poles because the acceleration and magnetic field vectors are perpendicular and parallel respectively that may cause increased error and poor results.

The method 1100 may further include the step of evaluating the quality of the attitude calibration using the χ² test and the Root Mean Square Error (RMSE) of the measured dot product relative to the true dot product [block 1103]. Calibration data that does not meet the desired significance of the χ² test may be rejected. The RMSE rejection may be set at three times the standard deviation of the calibrated sensor dot product when stationary. For more conservative evaluations, other criteria may be selected as appreciated by those skilled in the art.

The method 1100 may also include the step of calibrating the acoustic axes by repeating the use of the DPI method [block 1104]. This may provide the relative values of the shape matrix. Absolute values may also be provided when the pressure of the acoustic source is known or predetermined. Alternatively, the acoustic accelerometers 9 may be scaled using the hydrophone 10. In some embodiments, this method 1100 may result in the relative calibration of the sensor 1 by using the calibration step shown in FIG. 1.

An advantage of certain embodiments may include the tetradecahedron representation 17 providing high levels of calibration accuracy without expensive fixtures. Furthermore, in some embodiments, the tetradecahedron representation 17 may require no external standards for calibration of attitude sensors 1. A benefit may include application of the disclosed statistical measures to allow immediate feedback regarding calibration accuracy. In accordance with certain embodiments, the presently disclosed methods 1100 may be used with a simple shaker to calibrate acoustic axes that use accelerometer technology. Additional advantages include the elimination of the inaccuracies associated with random motion calibration or visual positioning for calibration.

As described herein, the Dot Product Invariance method may be effectively used to calibrate the magnetic sensors and acoustic sensors of a vector sensor 1. These calibrations may account for drift over time of the magnetic sensor and may be easily accomplished without expensive calibration systems. Field calibration may be performed for the attitude sensor, and an inexpensive wave guide or shaker may be used for the acoustic axe calibrations. The disclosed calibration may ensure that no movement acceleration is imparted to the sensor 1. In some embodiments, two above-described metrics maybe used to evaluate the calibration performance prior to fielding.

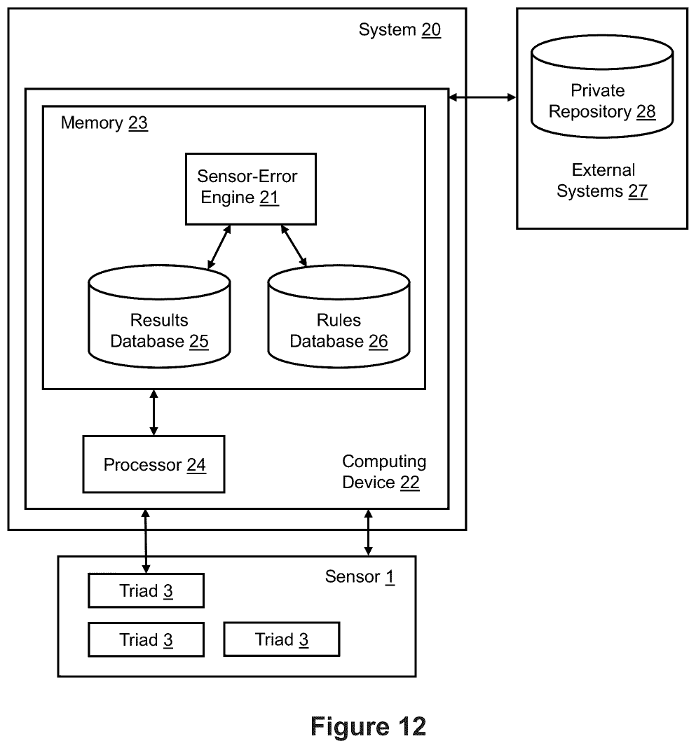

Embodiments of the disclosed system may be implemented in many different ways, using various components and modules, including any combination of circuitry described herein, such as hardware, software, middleware, application program interfaces (APIs), and/or other components for implementing the corresponding features of the circuitry. In some embodiments, the system 20 may include a sensor-error engine 21, as further described below. In an embodiment, as shown in FIG. 12, the system 20 may include a computing device 22, which may include a memory 23 and a processor 24. The system 20 may communicate with remote graphical user interfaces (GUIs) used to facilitate the importation and exportation of measured data. As such, users and administrators (admins) may remotely interface with the system 20 via the GUI. In some embodiments, the memory 23 may include the components and modules of the system 20, including the sensor-error engine 21. The sensor-error engine 21 may be configured: to receive a shape matrix; generate output data, which may comprise measurement yields based on sensor-error models; and, generate visual images, such as a spherical representation 16 or a tetradecahedron representation 17. In an embodiment, the images may be transmitted to an user or admin for further visual observation via a monitor or display screen. In addition, the sensor-error engine 21 may store the generated output data and images in a results database 25. The system 20 may also include a rules database 26 that stores the rules (not shown), such as the dot product rules described above. The databases 25/26 may comprise relational databases, such as a MySQL database, or an object-relational database, such as a PostgresSQL database. The databases 25/26 may be stored in the memory 23 of the system 20, or distributed across multiple devices, processing systems, or repositories. For example, the computing device 22 may be configured to communicate with various external systems 27 that may comprise private repositories 28. The computing device 17 may communicate with, and control, the sensor 1 and one or more of the sensor elements or triads 3.

While the present disclosure has been particularly shown and described with reference to an embodiment thereof, it will be understood by those skilled in the art that various changes in form and details may be made therein without departing from the spirit and scope of the present disclosure. Although some of the drawings illustrate a number of operations in a particular order, operations that are not order-dependent may be reordered and other operations may be combined or broken out. While some reordering or other groupings are specifically mentioned, others will be apparent to those of ordinary skill in the art and so do not present an exhaustive list of alternatives. The presently disclosed equations are examples, which may vary as understood by those skilled in the art, that are listed in order to illustrate the nature of certain embodiments.

1. A method for calibrating a sensor, comprising the steps of:
calibrating an attitude accelerometer of the sensor using an elliptical-fitting method, wherein the step of calibrating the attitude accelerometer is based on calibration positions;
calibrating a magnetometer of the sensor using a dot-product invariance method, wherein the step of calibrating the magnetometer is based on the calibration positions, whereby the dot-product invariance method generates magnetometer dot-products of magnetic field vectors and acceleration field vectors for the magnetometer; and,
determining a magnetometer-calibration status of the magnetometer based on a chi squared distribution test method and a root mean square error (RMSE) method of the generated dot-products, wherein the magnetometer-calibration status is based on a significance-level for a chi squared distribution and a maximum RMSE value, wherein the maximum RMSE value is based on the standard deviation of measured dot-products of the magnetometer when the sensor is held stationary.

2. The method of claim 1, further comprising the step of:
calibrating an acoustic accelerometer of the sensor using the dot-product invariance method, whereby the dot-product invariance method generates acoustic dot-products for the acoustic accelerometer, wherein the step of calibrating the acoustic accelerometer is based on relative-values of a shape matrix.

3. The method of claim 1, further comprising the step of:
scaling an acoustic accelerometer of the sensor using a hydrophone, wherein the hydrophone, the acoustic accelerometer, the attitude accelerometer and the magnetometer are mounted within the sensor.

4. The method of claim 1, further comprising the step of:
generating a matrix based on the measured dot-products and measured field vectors of Earth.

5. The method of claim 1, further comprising the step of:
rotating the sensor based on an acoustic source and magnetic north, wherein the sensor is rotated within a magnetic field by avoiding axes-alignment with the magnetic north.

6. The method of claim 1, wherein the calibration positions are based on a predetermined reference frame.

7. The method of claim 6, wherein the predetermined reference frame is based on a reference frame of the Earth.

8. The method of claim 6, wherein the predetermined reference frame is based on a North-East-Down (NED) coordinate system.

9. The method of claim 6, wherein the predetermined reference frame is based on a North-East-Down (NED) reference frame, wherein the NED reference frame comprises a Geodedic NED reference frame.

10. The method of claim 1, wherein the calibration positions comprise the off-axis positions of a tetradecahedron representation of the calibration positions.

11. The method of claim 2, wherein the step of calibrating the attitude accelerometer comprises receiving attitude values from the attitude accelerometer, wherein the step of calibrating the magnetometer comprises receiving magnetic values from the magnetometer, wherein the step of calibrating the acoustic accelerometer comprises receiving acoustic values from the acoustic accelerometer.

12. The method of claim 11, further comprising the step of:
converting the attitude values, the magnetic values and the acoustic values based on a reference frame of the sensor.

13. The method of claim 12, wherein the converting step comprises adjusting the attitude values, the magnetic values and the acoustic values based on calibration values, wherein the calibration values are generated using a linear least squares method.

14. The method of claim 12, further comprising the step of:
rotating the reference frame of the sensor to a North-East-Down (NED) reference frame, wherein the NED reference frame comprises a Geodedic NED reference frame.

15. The method of claim 14, wherein the rotating step comprises generating a rotation matrix based on the converted attitude values.

16. The method of claim 11, further comprising the step of:
aligning a sensing element selected from a group selected from consisting of the attitude accelerometer, the magnetometer and the acoustic accelerometer, whereby the sensing element is aligned based on a North-East-Down (NED) reference frame.

17. The method of claim 16, further comprising the step of:
determining an alignment of the sensing element based on a North-East-Down (NED) reference frame.

18. The method of claim 11, further comprising the step of:
aligning a sensor body of the sensor based on a North-East-Down (NED) reference frame.

19. The method of claim 1, further comprising the step of:
determining an orientation of the sensor based on a North-East-Down (NED) reference frame.

20. The method of claim 2, wherein the shape metric is based on acoustic dot-products for the acoustic accelerometer, wherein the shape matrix is used by a sensor-error engine to generate measurement yields using sensor error models, wherein the sensor error models comprise:
$$r = P a + e , for the attitude accelerometer , and$$
$$v = Km + b , for the magnetometer .$$

21. A system for implementing a method of claim 20 to calibrate the sensor, comprising:
a memory to store executable instructions; and,
a processor adapted to access the memory, the processor further adapted to execute the executable instructions stored in the memory to perform at least one of the steps of the method.
